(19) United States
(12) Patent Application Publication
(10) Pub. No.: US 2008/0078849 A1
(43) Pub. Date: Apr. 3, 2008

(54) Disposable spray gun cartridge

(76) Inventor: Jeffrey D. Fox, Nerstrand, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/540,747

(22) Filed: Sep. 30, 2006

(51) Int. Cl. B05B 1/30

(52) U.S. Cl. 239/583; 239/345; 239/302

(57) ABSTRACT

A disposable cartridge assembly for use with a paint spray gun is disclosed, being made out of an inexpensive material such as plastic, wherein the paint flows into the cartridge assembly and is sucked out of the tip of the cartridge assembly by the force of pressurized air flowing around the cartridge assembly and past the cartridge assembly fluid spray tip opening, thereby atomizing the paint allowing for an even application of the paint onto a working surface, such as an automobile body. The inexpensive material allows the cartridge to be disposed of after use, rather than cleaned. Further, keeping the paint within the cartridge assembly, and away from any inner workings of the paint spray gun, reduces or eliminates the need to clean the spray gun after use.

### FIELD OF THE INVENTION

This invention relates to improvements to a hand held spray gun specifically designed to be used with a cartridge assembly, such as those used for applying paint, and more particularly, to the disposability of the spray gun cartridge.

### BACKGROUND OF INVENTION

Spray guns are widely used in painting applications where even application of paint is required over fairly wide areas, such as motor vehicles when painting a vehicle following repair after an accident. Typically, in spray guns, the liquid is contained in a reservoir attached to the spray gun from which the liquid is fed to a spray nozzle. At the spray nozzle, compressed air atomizes the liquid into a spray which is then applied to the surface being painted. The liquid may be gravity fed, suction fed or even pressure fed by an air bleed line to the reservoir from the compressed air line to the spray gun.

Traditionally paint spray guns and paint spraying equipment must be thoroughly cleaned after each use, and much time is spent properly cleaning the equipment and parts of the spray gun. Solvent costs and the disposable waste generated by cleaning the spray gun add additional expense and waste. The present invention substantially reduces, and may even eliminate, that cost and waste.

Traditional spray guns also have set fluid tip sizes, or, if adjustable, must be thoroughly cleaned after each use. The present invention can be made in varying fluid tip sizes depending upon the application or painting project and do not require cleaning after use.

### SUMMARY OF THE INVENTION

The present invention provides a spray gun with a disposable cartridge assembly, the cartridge assembly body being hollow tube structure with an inner and an outer surface area, a reservoir connector, a fluid spray tip and fluid spray tip opening and a cap end opening, and further having a fluid needle, a fluid needle seal, a fluid needle washer, a fluid compression spring, an E-clip and a cap. The cartridge assembly would fit within a typical spray gun and be easily removable for disposal after its use. The cartridge assembly could also have various shapes and sizes to fit within a variety of spray guns. A reservoir would deliver liquid, such as paint, a chemical, a stain, a varnish or other sprayable liquid to the cartridge assembly through a reservoir connector and into the hollow body of the cartridge assembly. Pressurized air would flow into the spray gun, around the cartridge assembly and out the spray tip of the spray gun, thereby forcibly siphoning the liquid out of the cartridge assembly and atomizing the liquid for application onto the surface being sprayed. The reservoir holding the liquid could be attached to the cartridge assembly by the reservoir connector inlet opening, or the liquid could be delivered by tubing or some other means to the cartridge assembly. The reservoir connector inlet opening configuration would vary to match the particular type of reservoir or fluid hose from which the liquid would enter the cartridge assembly. The cartridge assembly body, fluid needle and cap could be made of a variety of inexpensive materials, such as plastic, metal, an alloy or some sturdy recycled material.

### BRIEF DESCRIPTION OF DRAWINGS

FIG. 1 is a cut-away view of the cartridge assembly.

FIG. 2 is an exploded view the cartridge assembly.

FIG. 3 is a cut-away view of a typical spray gun with the cartridge assembly contained therein.

### DETAILED DESCRIPTION OF DRAWINGS

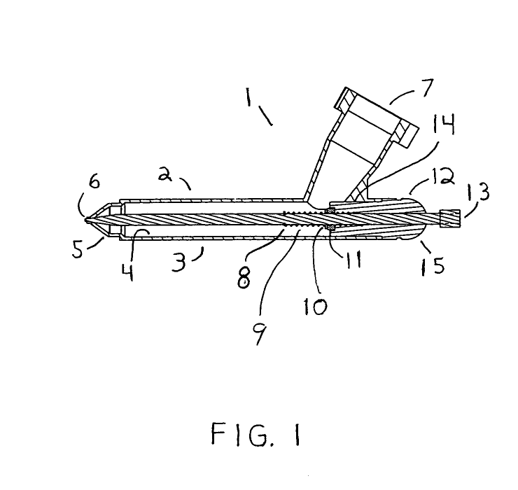

Referring to FIG. 1, the cartridge assembly 1 is shown cut in half lengthwise. The cartridge assembly 1 comprises a body 2, an outer surface 3, an inner surface 4, a tapered fluid spray tip 5, a fluid spray tip opening 6, and a connector inlet opening 7.

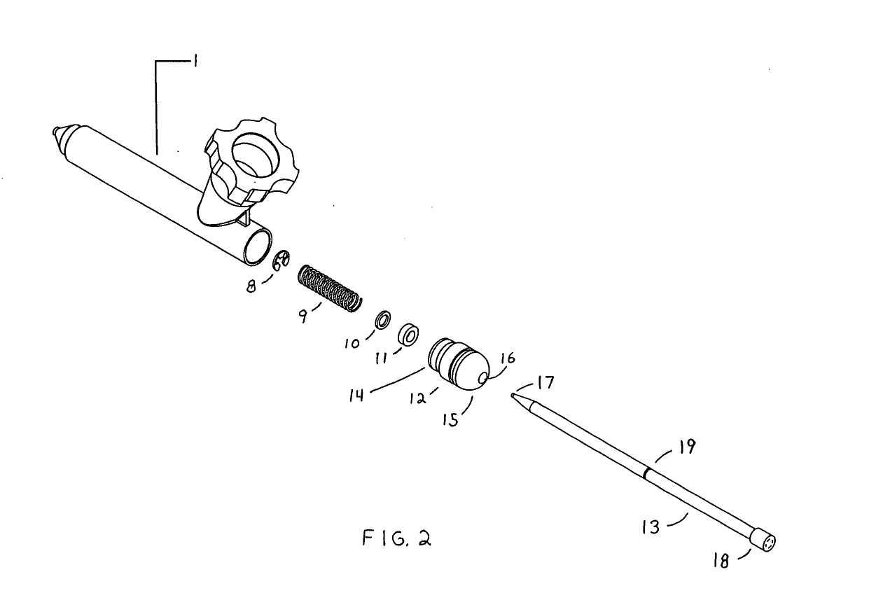

Referring now to FIG. 2, the cartridge assembly 1 is shown in exploded view, further comprising an E-clip 8, a fluid compression spring 9, a fluid needle washer 10, a fluid needle seal 11, a fluid cartridge end cap 12, and a fluid needle 13. The cartridge end cap 12 further comprises a fitting end 14 and a needle adjustment end 15. The cartridge end cap 12 further comprises a bore 16 from the fitting end 14 to the needle adjustment end 15. The bore 16 is of sufficient diameter to allow the fluid needle 13 to slide through the cartridge end cap 12.

Referring still to FIG. 2, the fluid needle 13 comprises a tapered spray tip end 17, a control end 18, and an annular groove 19 about midway between the tapered spray tip end 17 and control end 18. The fluid needle 13 has a diameter slightly smaller than the diameter of the cartridge end cap bore 16 such that the fluid needle 17 can slide within the bore 16 through the fluid cartridge end cap 12. The control end 18 has a diameter larger than the cap bore 16 to prevent the fluid needle 13 from passing entirely through the fluid cartridge end cap 12. In operation, the fluid needle 13 slides through the fluid cartridge end cap 12, tapered spray tip end 17 first through the needle adjustment end 18, the fluid needle seal 11 is situated around the fluid needle 13 and fits snugly inside the fluid cartridge end cap 12 thereby preventing the flow of liquid out through the bore 16, after which the fluid needle washer 10 is placed on the fluid needle 13, then the fluid compression spring 9 is placed on the fluid needle 13, and the e-clip 8 is fastened around the fluid needle 13 in the annular groove 19, thereby preventing the fluid compression spring 9 and the fluid needle washer 10 from sliding off the fluid needle 13. The fluid cartridge end cap 12 is then attached to the body 2 by inserting the fitting end 14 into the body 2 and securing the fluid end cap 12 to the body 2 with adhesive means. Friction can also hold the fluid end cap 12 onto the body 2 by having the fitting end be of sufficiently large diameter to fit snugly within the inner surface 4 of the body 2.

Referring again to FIG. 1, the cartridge assembly 1 is shown with the fluid needle 13 in its at rest position, wherein the tapered spray tip end 17 of the fluid needle 13 is seated within the fluid spray tip opening 6. While in its at rest position, no liquid can escape the cartridge assembly 1. In operation, the fluid needle 13 would be pulled out slightly from its seated position, thereby allowing liquid to escape through the fluid spray tip opening 6. A reservoir for liquid (not shown) would be attached to the reservoir connector inlet opening 7, allowing liquid to feed into the cartridge assembly 1 by means of gravity.

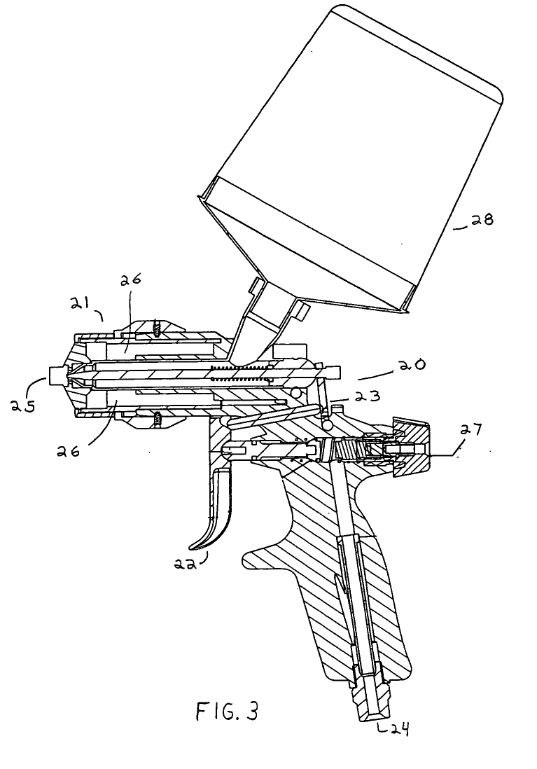

Referring to FIG. 3, a spray gun 20 is shown with the cartridge assembly 1 in place and the reservoir 28 attached to the reservoir connector inlet opening 7 of the cartridge assembly 1. In operation, the cartridge assembly fits within the barrel 21 of the spray gun 20 with the reservoir connector inlet opening 7 protruding from the barrel 21 such that a seal is formed around the reservoir connector inlet opening 7 to prevent the flow of air out of the barrel 21 around the reservoir connector inlet opening 7. The spray gun 20 comprises a trigger 22 that controls the amount of pressurized air flowing into the barrel 21 of the spray gun 20, a lever assembly 23, an inlet air port 24, and a nozzle 25. The trigger 22 is attached to the lever assembly 23 that actuates the fluid needle 13, moving the fluid needle 13 from its at rest position, thereby unseating the tapered spray tip end 17 of the fluid needle 13 from the fluid spray tip opening 6. Pressurized air flows into the spray gun 20 through an inlet air port 24 and flows through the spray gun 20, exiting at the nozzle 25. The cartridge assembly 1 fits within the barrel 21 of the spray gun 20 such that there exists a space 26 around the cartridge assembly 1 allowing the pressurized air to flow around and past the cartridge assembly 1, existing at the nozzle 25 of the spray gun 20. As the trigger 22 is pulled, the fluid needle 13 is moved out of its seated at rest position thereby allowing liquid fed by gravity from the reservoir 28 to the cartridge assembly 1 to escape from the fluid spray tip opening 6 and become atomized by the pressurized air flowing out of the nozzle 25 of the spray gun 20. A fluid adjuster knob 27, movably attached to the spray gun 20 limits the movement of the trigger 22, thereby controlling the amount of pressurized air entering the spray gun 20, which controls the amount of liquid escaping from the cartridge assembly 1. The amount of liquid that is sucked out of the fluid spray tip opening 6 of the cartridge assembly 1 is determined by the flow of pressurized air flowing past the fluid spray tip opening 6. The stronger the flow of pressurized air, the more liquid is sucked out of the fluid spray tip opening 6. The fluid spray tip opening 6 would have a diameter of sufficient size to suit the type of liquid being applied. Thinner liquids would require a smaller diameter fluid spray tip opening 6, while thicker liquids would require a larger diameter fluid spray tip opening 6.

No liquid touches any inner part of the spray gun 20, thus allowing for easy clean up after use. The cartridge assembly 1 and its components can be made of any number of inexpensive materials, such as plastic, thereby allowing the user to dispose of the cartridge assembly 1 after its use, thus substantially reducing or eliminating any cleaning.

1-4. (canceled)

5. A disposable cartridge assembly for use in spray guns comprising:
a tube, with a cap having an apex with an aperture therethrough at one end of the tube to permit fluids to pass therethrough, the second end of the tube having a cap with an aperture therethrough,
a needle having a tapered end for engaging the aperture in the apex of the cap and blocking a fluid from exiting therefrom, the needle slideably engaging the aperture at the second end of the tube while blocking fluid flow therethrough,
an aperture in the side of the tube for connection to a fluid supply, wherein the needle can be moved to allow a variable fluid flow out of the aperture of the apex.

6. A disposable cartridge assembly for use in spray guns as in claim 5 having,
a second tube connected to the aperture in the side of the tube, the second tube integral to the tube on one end and having a connector for attachment to a fluid container.

7. A disposable cartridge assembly for use in spray guns as in claim 5 having,
a spring connected to the needle and to the tube for biasing the needle to engage the apex to stop fluid flow.

8. A disposable cartridge assembly for use in spray guns as in claim 7 wherein, the spring surrounds the needle on the inside of the tube.

9. A disposable cartridge assembly for use in spray guns as in claim 5 having,
a nozzle on the housing adjacent the apex of the tube cap for controlling the spray emanating therefrom.

10. A disposable cartridge assembly for use in spray guns as in claim 5 having,
a spray gun housing for removeably containing the tube and having an air flow over the apex of the cap for entraining fluid from the tube out of the housing, and the housing having a lever attached to the needle adjacent the second end of the tube for adjusting the needle position relative the tube and thereby adjusting the fluid flow through the tube.

11. A disposable cartridge assembly for use in spray guns as in claim 5 wherein, the tube is plastic.

12. A disposable cartridge assembly for use in spray guns as in claim 6 wherein, the tube is plastic.

13. A disposable cartridge assembly for use in spray guns as in claim 7 wherein, the tube is plastic.

14. A disposable cartridge assembly for use in spray guns as in claim 8 wherein, the tube is plastic.

15. A disposable cartridge assembly for use in spray guns as in claim 9 wherein, the tube is plastic.

16. A disposable cartridge assembly for use in spray guns as in claim 10 wherein, the tube is plastic.

17. A disposable cartridge assembly for use in spray guns as in claim 11 wherein, the needle is plastic.

18. A disposable cartridge assembly for use in spray guns as in claim 12 wherein, the needle is plastic.

19. A disposable cartridge assembly for use in spray guns as in claim 15 wherein, the needle is plastic.

20. A disposable cartridge assembly for use in spray guns as in claim 16 wherein, the needle is plastic.
